(19) United States
(12) Patent Application Publication
(10) Pub. No.: US 2012/0116811 A1
(43) Pub. Date: May 10, 2012

(54) SCREEN-TOUCH-CONTROL ELECTRONIC DEVICE FOR PROVIDING MEDICAL INFORMATION

(76) Inventors: Lih-Ching CHOU, Taipei City (TW); Chi-Yuan Yu, Taipei City (TW); Yen-Yang Chen, Taipei City (TW); Yu-You Wang, Taipei City (TW)

(21) Appl. No.: 13/293,600

(22) Filed: Nov. 10, 2011

(30) Foreign Application Priority Data
Nov. 10, 2010 (TW) 99221764

(51) Int. Cl. G06Q 50/24

(52) U.S. Cl. 705/3

(57) ABSTRACT

A screen-touch-control electronic device for providing medical information includes a communication module, a memory module, a control module and a touch screen. The communication module is in signal connection with at least a server to download patient information. The patient information are selected from the group consisting of patient abstracts, medical records, medicine records, laboratory data, doctor orders and medical image information and any combination thereof. The memory module stores a medical information application program and the patient information downloaded through the communication module. The control module electrically connects with the communication module and the memory module, and performs the medical information application program to generate an information window. The touch screen electrically connects the control module, displays the information window and detecting a touch event to generate a touch signal. The control module receives the touch signal to display the patient information within the information window accordingly.

### CROSS-REFERENCES TO RELATED APPLICATIONS

This non-provisional application claims priority under 35 U.S.C. §119(a) on Patent Application No. 99221764 filed in Taiwan, R.O.C. on Nov. 10, 2010, the entire contents of which are hereby incorporated by reference.

### BACKGROUND

1. Technical Field

The disclosure relates to a screen-touch-control electronic device, and in particular to a screen-touch-controllable electronic device for providing medical information.

2. Related Art

Nowadays, hospitals are devoting their major efforts to digitalize medical records and networkize managements of medical information, thereby fulfilling the needs of exchanging and sharing clinic information between medical institutes. Namely, medical records may be exchanged between hospitals.

However, when inspecting medical wards, a doctor still needs to note patients' medical records or clinic test data by conventional handwriting. Such operation not only consumes doctors' precious time and increases doctors' loading, but also possibly causes improper doctor orders by mistakes or errors generated during handwriting and reading for sequent medical conducts.

A more precise and convenient approach is to dispose a notebook computer on a medical trolley, connect to the hospital database through and access digital medical records displayed in webpage interfaces. However, a medical trolley is movable but still lack of activeness. More importantly, the top space on a medical trolley is limited and actually not convenient for best computer operation, which might cause shortcomings such as wrong operations or time-consuming. Furthermore, a notebook computer requires high electrical power but the battery power can never provide enough support.

Currently, some hospitals start to implement Personal Digital Assistants (PDAs) for replacing the notebook computer such that doctors can have an easy-carry medical information device. Doctors are able to perform certain application program on the PDAs to connect with the internal information system(s) in the hospital and access patient information. Yet a PDA's screen size is not enough to display complex patient information, such as medical images.

Furthermore, there may be various types of medical information systems installed in a hospital. When a doctor is inspecting and checking patients in medical wards, he/she may need further patient information (such as clinic laboratory data and medical images) other than medical records. Therefore, notebook computers and PDAs are not able to provide doctors with all aspects of patient information.

### SUMMARY

Accordingly, in an embodiment of the disclosure, a screen-touch-control electronic device for providing medical information is disclosed to resolve doctors' problem of limited access to patient information when inspecting the patient rooms. Thus, doctors may conveniently review patient information through instinct touch-control operation.

In an embodiment, the electronic device includes a communication module, a memory module, a control module and a touch screen. The communication module is in external signal connection with a server. One or multiple sets of patient information regarding a patient are downloaded from the server and through the communication module. The patient information is selected from the group consisting of patient abstracts, medical records, medicine records, laboratory data, doctor orders and medical image information and any combination thereof. The memory module stores a medical information application program and the patient information downloaded through the communication module. The control module electrically connects with the communication module and the memory module, performing the medical information application program to generate an information window. The touch screen electrically connects the control module, displays the information window and detects a touch event to generate one or more touch signals. The control module receives the touch signal and displays the patient information within the information window according to the received touch signal.

In another embodiment of the disclosure, through the communication module, the control module downloads from the server to update the set of patient information stored in the memory module. Thus, doctors are able to instantly update patient information and really control the current status of the patient.

In another embodiment of the disclosure, through the communication module, the control module uploads to update the set of the patient information stored in the memory module to the server. Thus, doctors are able to review the uploaded and updated patient information from the server, thereby making proper doctor orders accordingly.

Therefore, the disclosed device allows a doctor to conveniently access sets of patient information stored within various types of medical information system in a hospital. Doctors are able to give doctor orders based on various sets of medical information so that patients may have more reliable medical treatments.

### BRIEF DESCRIPTION OF THE DRAWINGS

The disclosure will become more frilly understood from the detailed description given herein below for illustration only, and thus are not limitative of the disclosure, wherein:

FIG. 1 is an explanatory diagram for a practical application of a screen-touch-control a medical information device a medical information device according to an embodiment;

FIG. 2 is a systematic block diagram of a screen-touch-control medical information device according to an embodiment;

FIG. 3 is a screen diagram for a patient management interface of a medical information application program installed on a medical information device according to another embodiment;

FIG. 4 is a screen diagram for a patient abstract interface of a medical information application program installed on a medical information device according to another embodiment;

FIG. 5 is a screen diagram for a laboratory data interface of a medical information application program installed on a medical information device according to another embodiment;

FIG. 6 is a screen diagram for a medical record interface of a medical information application program installed on a medical information device according to another embodiment;

FIG. 7 is a screen diagram for a doctor order interface of a medical information application program installed on a medical information device according to another embodiment;

FIG. 8 is a screen diagram for a medicine record interface of a medical information application program installed on a medical information device according to another embodiment;

FIG. 9 is a screen diagram for a medical image information of a medical information application program installed on a medical information device according to another embodiment;

FIG. 10 is another screen diagram for a set of medical image information of a medical information application program installed on a medical information device according to another embodiment;

FIG. 11 is another screen diagram for a set of medical image information rotated from the medical image shown in FIG. 10;

FIG. 12 is another screen diagram for another set of medical image information of a medical information application program installed on a medical information device according to another embodiment;

FIG. 13 is a screen diagram for a note writing interface of a medical information application program installed on a medical information device according to another embodiment; and

FIG. 14 is a systematic block diagram of a medical information application program installed on a medical information device according to another embodiment.

### DETAILED DESCRIPTION

The following practical embodiments are described in detail with accompanying drawings to explain the scopes of the disclosure. Components of the disclosure are marked with appropriate numerals.

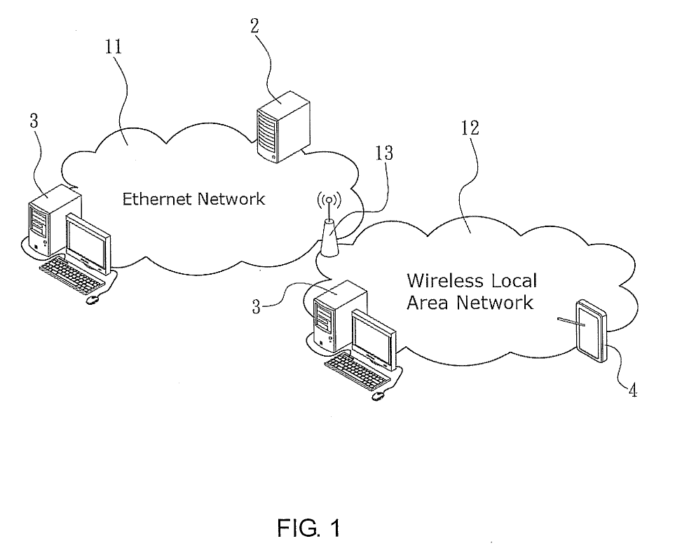

Please refer to FIG. 1, which is an explanatory diagram for a practical application of a screen-touch-control electronic device according to an embodiment. A hospital internal network is established by Ethernet network 11 and WLAN (Wireless Local Area Network) 12, which are connected with each other by Access Point (AP) 13. Server 2 connects to the hospital internal network through Ethernet network 11. Doctors in the hospital may use personal computer 3 to connect with server 2 through the hospital internal network and to access patient information of patients.

The screen-touch-control electronic device for providing medical information (hereinafter abbreviated as “medical information device 4” with a numeral “4” marked in the accompanying drawings) is connected to server 2 through the hospital internal network so as to access patient information of patients. In an embodiment, based on the need of movements for medical-related tasks, medical information device 4 is connected to server 2 through WLAN 12. Thus, when inspecting and checking patients, a doctor may carry medical information device 4 to review the patients' patient information, give doctor orders and send by to server 2.

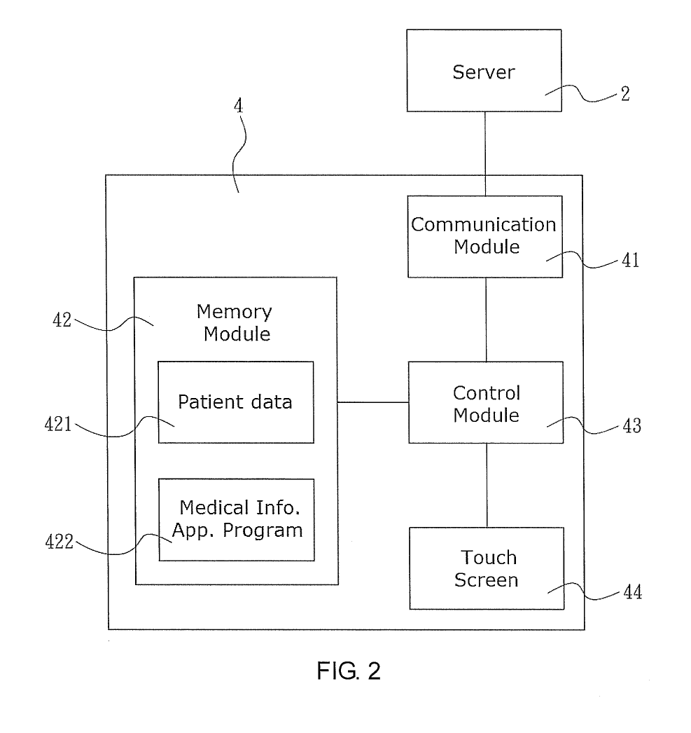

Please refer to FIG. 2, which is a systematic block diagram of a screen-touch-control electronic device according to an embodiment. The screen-touch-control electronic device for providing medical information (medical information device 4) mainly includes a communication module 41, a memory module 42, a control module 43 and a touch screen 44. In an embodiment, medical information device 4 is realized by a touch-control tablet computer, or by a touch-control multimedia device with a touch screen larger than a PDA.

Referring to FIG. 2, communication module 41 is connected to one or more external server 2 with signal communications in between; namely, communication module 41 is in external signal connection with server 2. Communication module 41 downloads one or more sets of patient information 421 regarding a patient from server 2. Memory module 42 stores medical information application program 422 and the sets of patient information 421 downloaded by communication module 41. Control module 43 electrically connects with communication module 41 and memory module 42, and performs the medical information application program 422 to generate an information window. Touch screen 43 electrically connects with control module 43, displays the information window, and also detects one or more touch events to generate one or more touch signals. Control module 43 receives the touch signals and then displays the set(s) of patient information 421 within the information window.

In different embodiments, the touch event is a Single-Point Touch event or a Multi-Touch event. Single-point touch event is detected when a user touches a virtual button and/or hyperlink displayed on touch screen 44; wherein the virtual button and/or hyperlink is displayed when medical information application program 422 is performed by control module 43. A series of sequent single-point touch events are able to be transformed into handwriting path and initiate procedures of handwriting recognition. Multi-touch event is recognized by procedures of gesture recognition to proceed with corresponding operations, such as a Pinch-to-Zoom gesture may be defined as enlarging the information window. Such example is only disclosed for explanation purpose and should not become limitation to the disclosure. A single-point touch event may also be integrated with multi-touch event. For example, the information window may be enlarged by a multi-touch event; and then through a single-point touch event, the information window is dragged and move aside so that the user is able to review information displayed outside of the information window.

In an embodiment, communication module 41 is realized by a wireless local area network module. Control module 43 is realized by a central processing unit (CPU) or an Accelerate Processing Unit (APU) integrated with CPU and graphic processing unit (GPU).

Server 2 includes one or more system selected from the group consisting of History Information System (HIS), Electronic Medical Record (EMR), Picture Archiving and Communication System (PACS), Radiology Information Systems (RIS) and Laboratory Information System (LIS) and any combination thereof. In an embodiment, an interface server may be used to connect server 2 with different medical information systems (such as HIS, EMR, PACS and etc.), thereby transmitting different sets of patient information 421 collected from each of the medical information systems respectively to medical information device 4. Alternatively, medical information device 4 is connected to each of the medical information systems.

The patient information 421 may be selected from the group consisting of patient abstracts, medical records, medicine records, laboratory data, doctor orders and medical image information and any combination thereof. The patient abstract is noted with data of the patient's “Vital Signs”, “Past Medical History”, “Chief Complaint”, “Impression” and major medical laboratory data, such that the doctor can be familiar with the patient's status in a short time. Medical record includes the records of the patient's hospitalization processes (inbound or outbound), clinic diagnosis, and joint diagnosis. Medicine records indicate medicine names and dosages of long-term treatments, short-term treatments, current treatments and allergic medicines. Laboratory data includes laboratory test reports from different medical departments. Doctor orders include doctor's advices, prescriptions and any related information from the doctor. Medical image information includes medical images and records of the patients, such as Computerized Tomography (CT), Positron Emission Tomography (PET), Magnetic Resonance Imaging (MRI), Medical Ultrasonography and common X-ray images.

Memory module 42 with multiple sets of patient information 421 stored thereon may be realized by Non-Volatile Memory and imbedded inside medical information device 4. In another embodiment, the memory module includes an external memory device (such as a memory card), such that the memory capacity is expanded to store more sets of patient information 421.

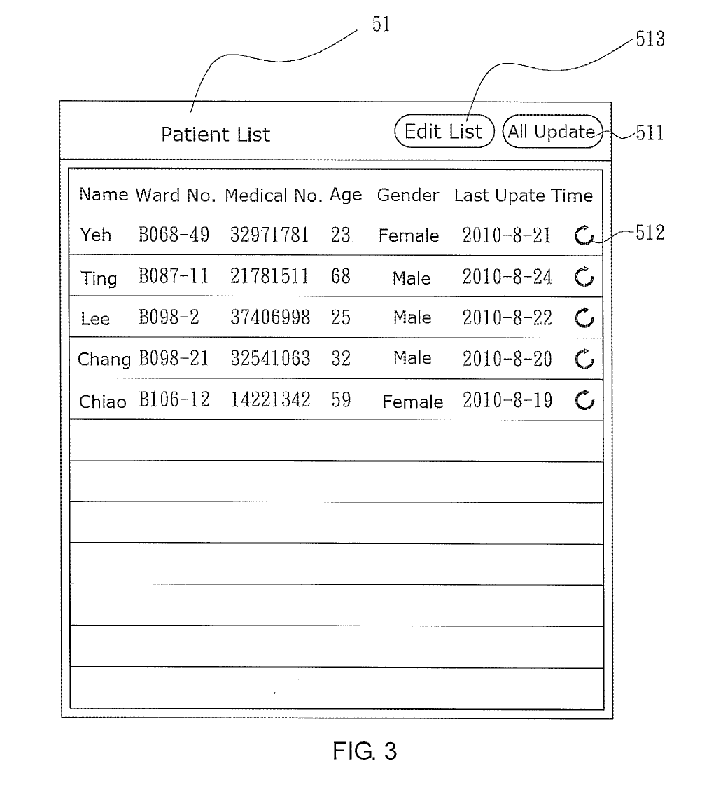

Please refer to FIG. 3, which is a screen diagram for a patient management interface of a medical information application program installed on a medical information device according to another embodiment. When the medical information device 4 is connected with server 2, a doctor may input a doctor user name and password to enter the patient management interface. Then a patient list 51 is displayed on touch screen 44; the doctor is able to add and delete patients or update all the sets of patient information 421. The update operation of patient information 421 includes all updates for all listed sets of patient information 421 and partial updates for one or more selected sets of patient information 421, which are respectively corresponds to “All Update” button 511 and a partial update icon 512. When “Edit List” button 513 is clicked, medical information device 4 allows the doctor to add or delete patient's records on the list.

The aforesaid update operation includes download one or more sets of patient information 421 stored in server 2 to medical information device 4, and also replace the older sets of patient information 421. Namely, through communication module 41, control module 43 downloads from the server 2 to update the set of patient information 421 of a patient stored in the memory module42.

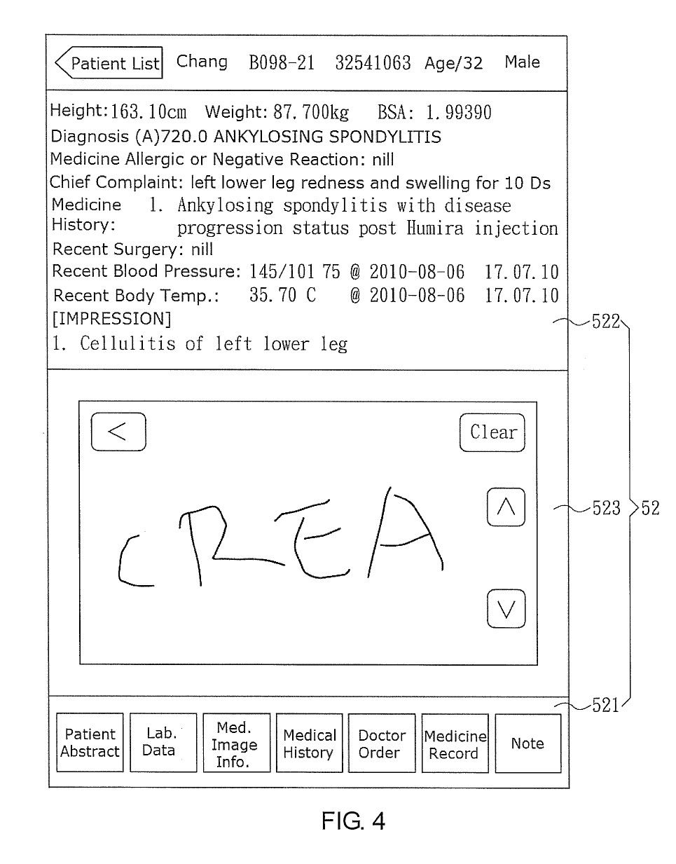

Please refer to FIG. 4, which is a screen diagram for a patient abstract interface of a medical information application program installed on a medical information device according to another embodiment. After selecting a patient from the patient list 51, the dedicated set of patient information 421 for the selected patient is displayed on touch screen 44. In an embodiment, control module 43 displays the patient information 421 within the information window in a way of displaying only a portion of the patient information 421. In the information window, the doctor may instantly update the patient information 421, to precisely control the status of the patient.

Refer to FIG. 4, taking the patient abstract interface as an example, information window 52 includes patient information switch portion 521 and patient information displaying portion 522. The patient information switch portion 521 include independent selectable items for various sets of patient information 421, each of which hyperlinks to operation interfaces regarding patient abstracts, medical records, medicine records, laboratory data, doctor orders or medical image information. The patient information displaying portion 522 displays the patient information 421 selected at the patient information switch portion 521. In the patient abstract interface, the information window 52 further includes a note portion 523, in which a touch path is detected for handwriting recognition; the detect touch path of handwriting is stored in memory module 42 in the format of digital image file. Note portion 523 allows the doctor to write things down and save in the medical information device 4; which replaces conventional papers and pens. The doctor now only needs to carry the medical information device 4; all the sets of patient information 421 can be instantly accessible and the latest patient status may be recorded into the medical information device 4 and also uploaded to the server 2.

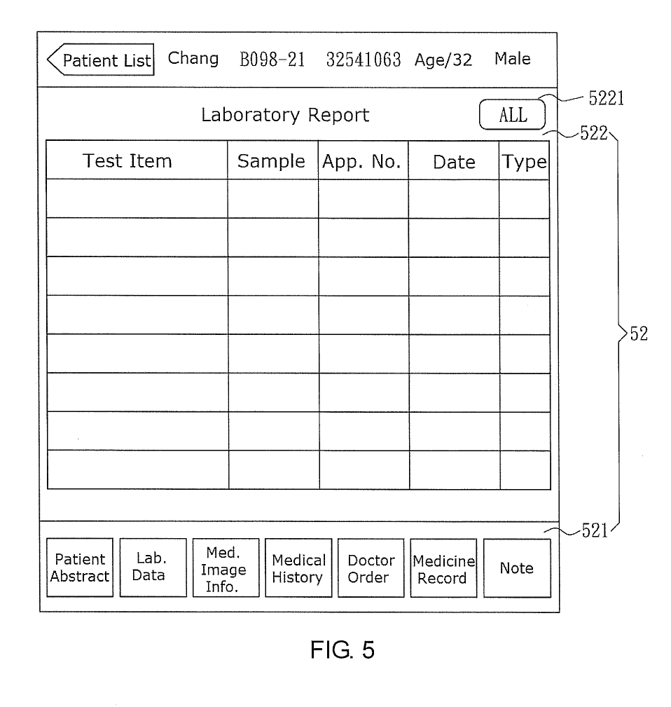

Please refer to FIG. 5, which is a screen diagram for a laboratory data interface of a medical information application program installed on a medical information device according to another embodiment. The patient information displaying portion 522 includes a department selection item 5221 for the doctor to access the laboratory data from a specific department or to display laboratory data from all departments.

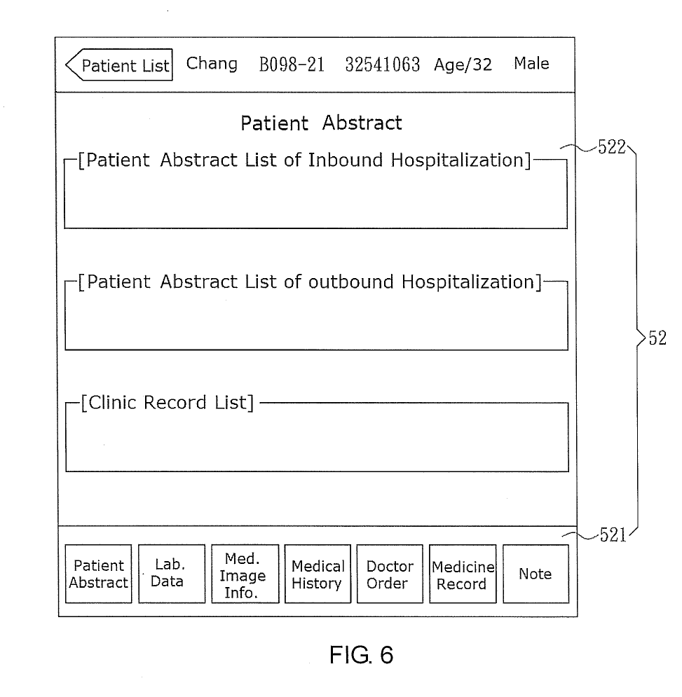

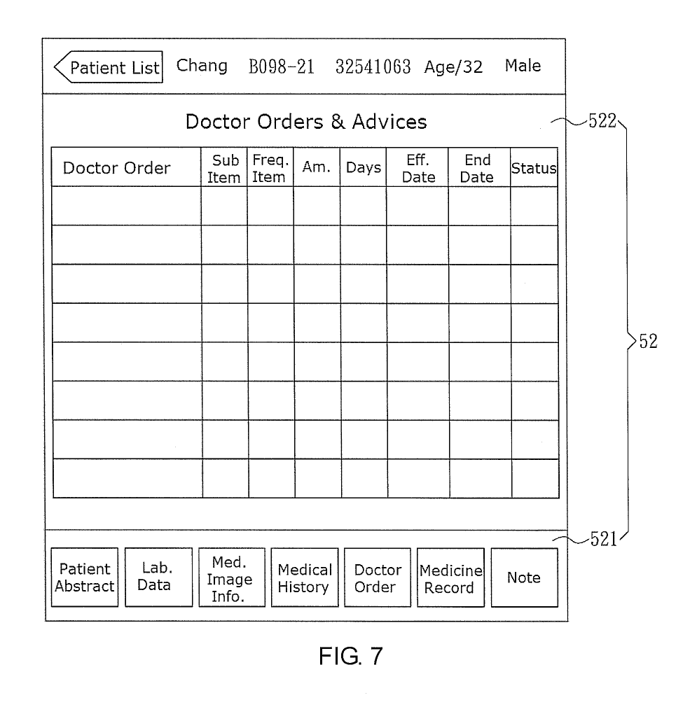

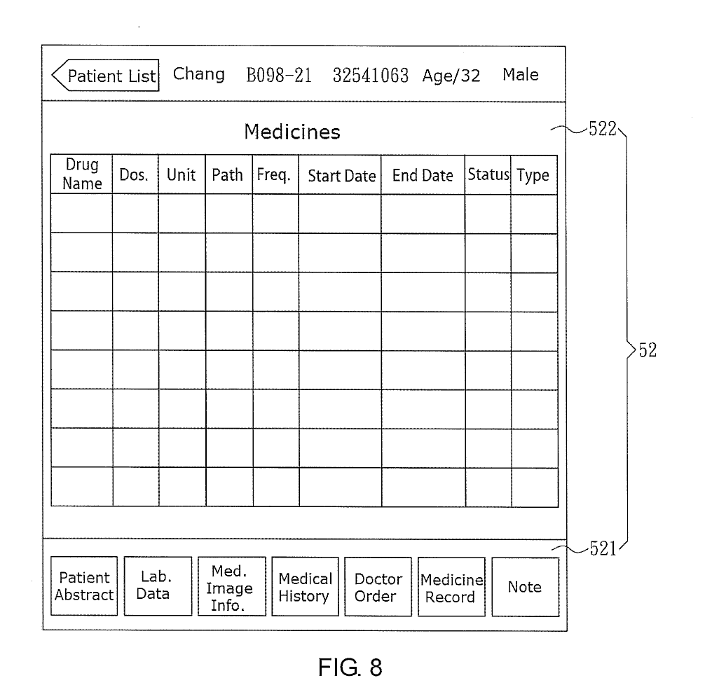

Please refer to FIG. 6 to FIG. 8. FIG. 6 is a screen diagram for a medical record interface of a medical information application program installed on a medical information device according to another embodiment; FIG. 7 is a screen diagram for a doctor order interface of a medical information application program installed on a medical information device according to another embodiment; and FIG. 8 is a screen diagram for a medicine record interface of a medical information application program installed on a medical information device according to another embodiment.

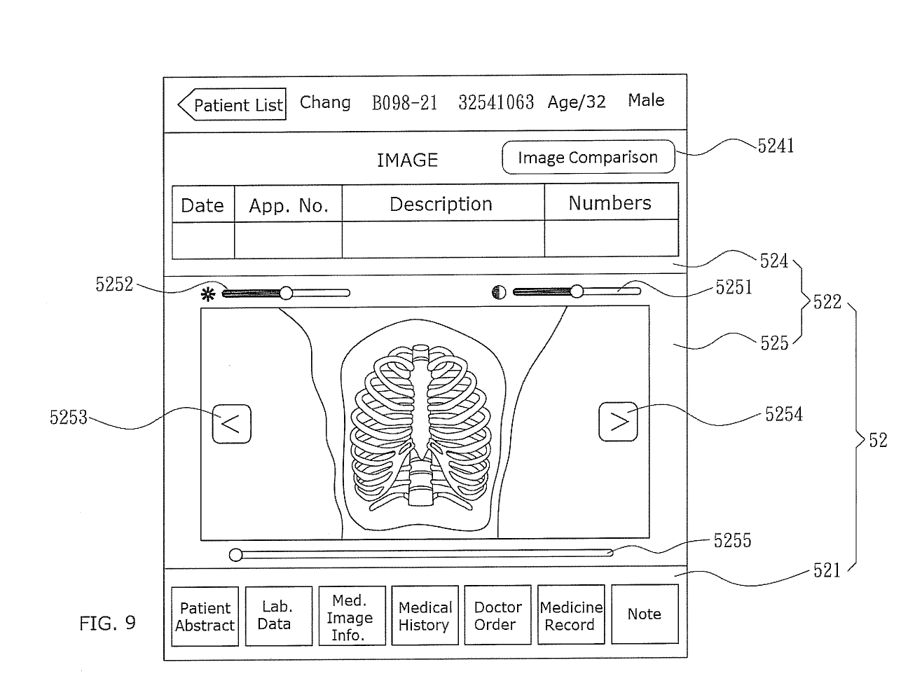

Refer to FIG. 9, which is a screen diagram for a set of medical image information of a medical information application program installed on a medical information device according to another embodiment. The patient information displaying portion 522 includes an image list 524 and an image displaying portion 525. Image list 524 includes multiple medical image records and hyperlinks to image files, such that the doctor may select one to display the corresponding medical image file in the image displaying portion 525.

In an embodiment, the image displaying portion 25 may include a contrast adjusting bar 5251 and a brightness adjusting bar 5252 for respectively adjusting the contrast and brightness of the displayed medical image. Thus, the doctor would be able to review and recognize the details of the medical image. Furthermore, image displaying portion 525 includes a “forward” button 5253 and a “backward” button 5254, each respectively hyperlinked to the former displayed medical image file and the next displayed medical image file. In an embodiment, image displaying portion 525 further includes a file review bar 5255, which provides a fast review mode of multiple medical image files through dragging operation on the file review bar 5255.

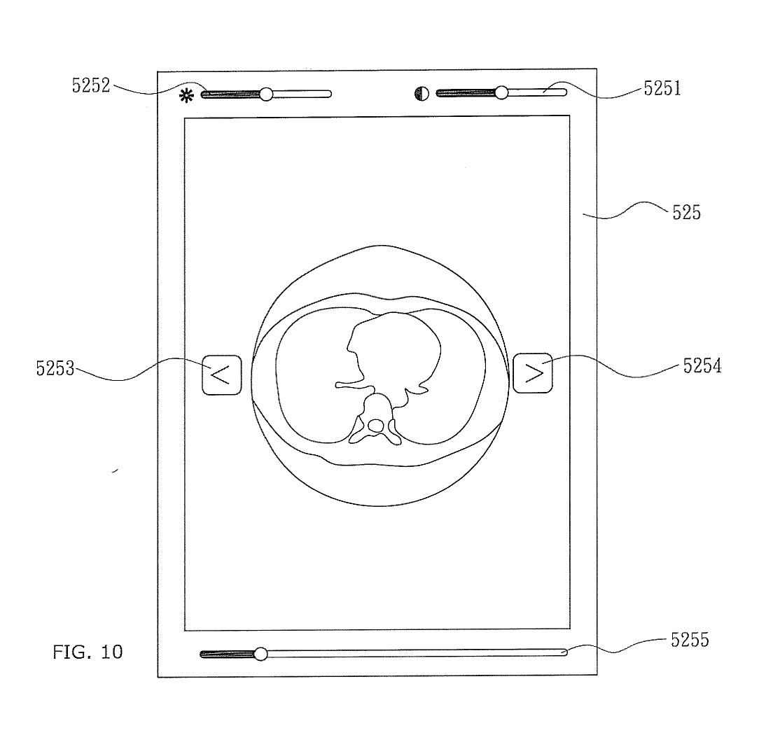

Refer to FIG. 10, which is another screen diagram for a set of medical image information of a medical information application program installed on a medical information device according to another embodiment. In FIG. 10, the medical image is displayed on the touch screen 44 in a full-screen mode. For example, when double clicking the image displaying portion 525, the medical image is enlarged to the Rill-screen size on the touch screen 44; certainly, such example is for explanation purpose only and should not be considered as limitations to the disclosure.

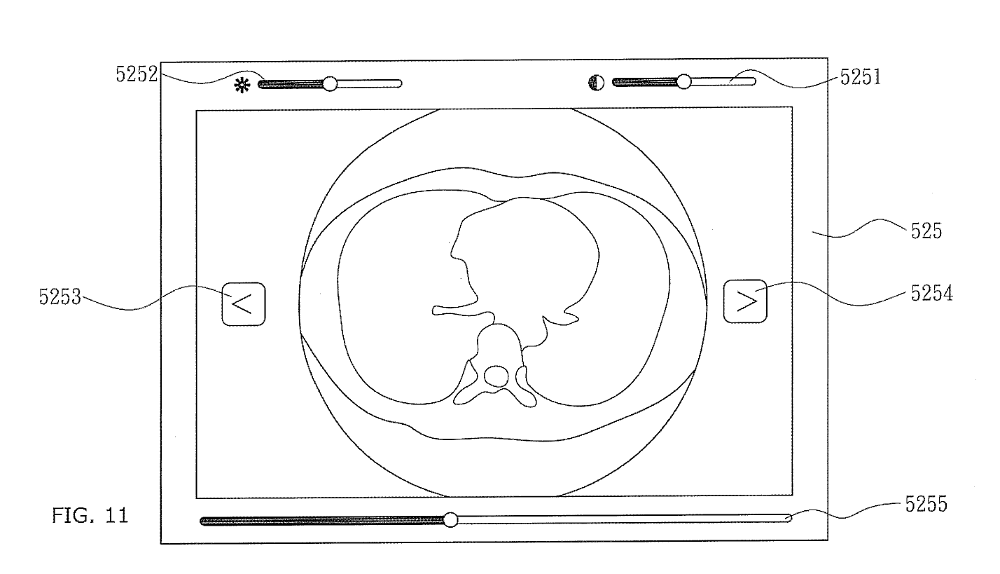

Refer to FIG. 11, which is another screen diagram for a set of medical image information rotated from the medical image shown in FIG. 10. In an embodiment, the medical information device 4 further includes a direction sensing module (such as acceleration sensor or gyro sensor). The direction sensing module detects the direction that the medical information device 4 is disposed to display the information window in a corresponding direction. Thus, the doctor can intuitively rotate the medical information device 4 by 90 degree and dispose it on a table, the information window 52 will then rotate accordingly and automatically adjust the image ratio of the medical image file to match the touch screen.

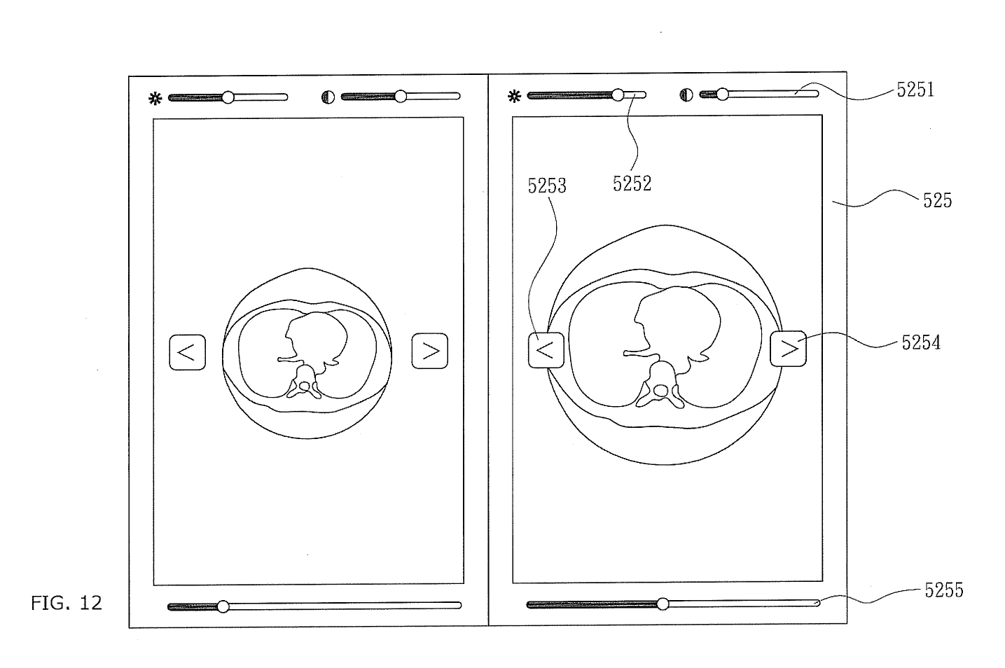

Refer to FIG. 12, which is another screen diagram for another set of medical image information of a medical information application program installed on a medical information device according to another embodiment. When a first medical image file is selected, the image comparison button 5241 may be clicked to select a second medical image. The first and second medical images are displayed in parallel within the information window on the touch screen 44. Thus, the doctor may review related medical images that are displayed in parallel for better review and comparison.

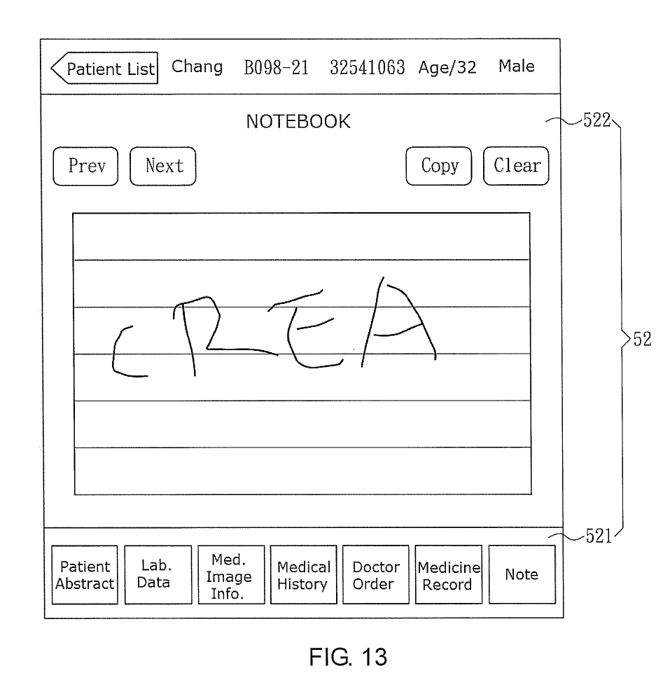

Refer to FIG. 13, which is a screen diagram for note writing of a medical information application program installed on a medical information device according to another embodiment. The patient information switch portion 521 further includes a “Note” button, hyperlinked to a note writing interface that displays the handwriting path recorded from the note portion 523 in FIG. 4; such handwriting image is first stored in memory module 42.

The patient information 421 mentioned above is downloaded from the server 2 to medical information device 4. However, medical information device 4 may also upload the latest patient information 421 to server 2. For example, when the doctor is inspecting the medical wards and checking the status of patients, one or more doctor orders may be issued according to the latest status of the patients; such latest doctor orders may be uploaded to server 2. Namely, through communication module 41, one or more sets of patient information 421 of one or more patients newly stored into memory module 42 is uploaded by the control module 43 to update to server 2.

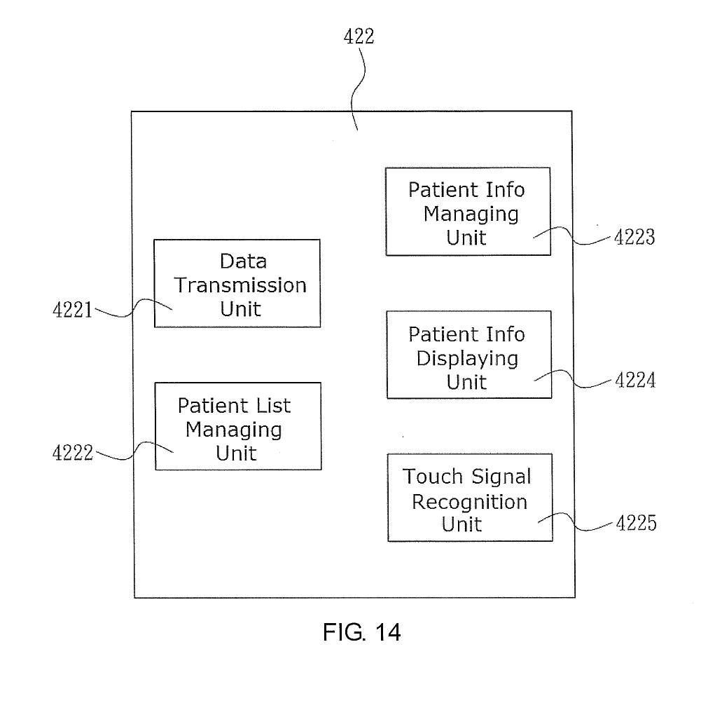

Please refer to FIG. 14, which is a systematic block diagram of a medical information application program installed on a medical information device according to another embodiment. The medical information application program 422 includes an information transmission unit 4221, a patient list managing unit 4222, a patient information managing unit 4223, a patient information displaying unit 4224 and a touch signal recognition unit 4225; each of which includes computer performable procedures.

Information transmission unit 4221 is used to provide log-in interface, manage accounts and transmit/receive the patient information 421 in one or more specific format(s). The specific format may be HL7 (Health Level Seven), DICOM (Digital Imaging and Communications in Medicine) or any other self-defined format. Patient list managing unit 4222 is used to manage the patient list 51 shown in FIG. 3. Patient list managing unit 4222 increase or delete items included in patient list 51 and store patient list 51 in the memory module 42.

Patient information managing unit 4223 is used to update the patient information 421 corresponding to the edited patient list 51. Patient information managing unit 4223 performs tasks including: updating the patient information 421 stored on server 2 to the memory module 42; and updating the newly added/edited contents of the patient information 421 stored in memory module 42 to server 2.

Patient information displaying unit 4224 is used to perform an operation of displaying the information window 52 and display the corresponding patient information 421 according to touch events detected from the touch screen 44. Such operation includes determines the positions of touch events through the interpretation of touch signals by the touch signal recognition unit 4225, and determine if the touch events matches the positions of virtual buttons or hyperlinks within information window 52. Thus, Patient information displaying unit 4224 may further provide corresponding information based on the virtual button or hyperlink clicked via touch events. Alternatively, a touch path detecting process may be performed in a certain area (such as the note portion 523) within the information window, and displays the touch path in information window 52 by information displaying unit 4224. Furthermore, when a multi-touch event is detected, a touch gesture would then be input and information displaying unit 4224 further display an enlarged/shrunk or rotated information window in response to the multi-touch event.

Thus, control module 43 is able to determine the way how the patient information 421 is displayed within information window 52 and how the information window 52 is illustrated according to the touch events and signals.

In short, the screen-touch-control electronic device for providing medical information (medical information device 4) disclosed in the embodiments above, integrates patient information from different systems in a hospital. The electronic device may be hand carry by doctors to fulfill the needs of instantly accessing patient information when inspecting the medical wards or checking the patients. Therefore, doctors or nurses would be able to provide better medical treatments for patients.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An electronic device for providing medical information, comprising:
a communication module in external signal connection with at least a server, at least one set of patient information regarding at least a patient being downloaded from the server and through the communication module, the patient information being selected from the group consisting of patient abstracts, medical records, medicine records, laboratory data, doctor orders and medical image information and any combination thereof;
a memory module, storing a medical information application program and the patient information downloaded through the communication module;
a control module electrically connected with the communication module and the memory module, performing the medical information application program to generate at least an information window; and
a touch screen, electrically connecting the control module, displaying the information window, and detecting a touch event to generate at least a touch signal, the control module receiving the touch signal and displaying the patient information within the information window according to the received touch signal.

2. The electronic device as claimed in claim 1, wherein the control module displays only a portion of the patient information within the information window.

3. The electronic device as claimed in claim 1, wherein the control module displays an enlarged portion of the information window when the patient information is displayed within the information window.

4. The electronic device as claimed in claim 1 further comprising a direction sensing module, the direction sensing module detecting the direction that the electronic device is disposed to display the information window in a corresponding direction.

5. The electronic device as claimed in claim 1, wherein the control module displays a corresponding medical image in a full-screen mode on the touch screen when the patient datum is the medical image information.

6. The electronic device as claimed in claim 1, wherein the touch event is a multi-touch event.

7. The electronic device as claimed in claim 1, wherein through the communication module, the control module downloads from the server to update the set of patient information stored in the memory module.

8. The electronic device as claimed in claim 1, wherein through the communication module, the control module uploads to update the set of the patient information stored in the memory module to the server.

9. The electronic device as claimed in claim 1, wherein the server comprises a system selected from a group consisting of History Information System (HIS), Electronic Medical Record (EMR), Picture Archiving and Communication System (PACS), Radiology Information Systems (RIS) and Laboratory Information System (LIS) and any combination thereof.
